(19) United States
(12) Patent Application Publication
(10) Pub. No.: US 2024/0392212 A1
(43) Pub. Date: Nov. 28, 2024

(54) Compositions and Methods for Decontamination of Hazardous-Porous Material

(71) Applicants: Llyod LUDLOW, Sandy Hook, VA (US); Phoenix Brands, Sandy Hook, VA (US)

(72) Inventor: Lloyd Ludlow, Sandy Hook, VA (US)

(73) Assignee: Phoenix Brands LLC, Sandy Hook, VA (US)

(21) Appl. No.: 18/690,928

(22) PCT Filed: Sep. 9, 2022
(86) PCT No.: PCT/US2022/043027

§ 371 Date: Mar. 11, 2024

Related U.S. Application Data
(60) Provisional application No. 63/242,112, filed on Sep. 9, 2021.

(51) Int. Cl. C11D 1/83; B09B 3/23; B09B 101/35; C11D 1/14; C11D 1/72; C11D 1/75; C11D 3/36

(52) U.S. Cl. CPC C11D 1/83; B09B 3/23; C11D 3/362; B09B 2101/35; C11D 1/146; C11D 1/72; C11D 1/75

(57) ABSTRACT

Chemical compositions may be used to dissolve coatings and at least partially encapsulate potentially hazardous fibers or potentially hazardous particles in the coating. The chemical composition for use in the removal of a textured or smooth surface comprising asbestos may comprise an aqueous solution comprising a surfactant package and triethyl phosphate. In certain embodiments, the surfactant package may comprise an alcohol ethoxylate surfactant and sodium lauryl sulfate.

### TECHNICAL FIELD

Coatings containing asbestos must be carefully removed to prevent airborne dust. Chemical compositions may be applied to the coating prior to removal to prevent worker inhalation of hazardous particles or fiber.

### BACKGROUND

Many buildings contain Artex and other types of textured coatings on walls and ceilings. Such textured ceilings that may contain asbestos. Asbestos fibers were added to give the textured coatings strength and prevent cracking.

Removal, renovation or otherwise disturbing the coating may release these potentially hazardous fibers or particles. Asbestos was a popular in building material because it was cheap, durable, and strong. But was then banned due to the potential problems with inhalation of airborne fibers that may lead to mesothelioma. Unfortunately, asbestos is still present in many homes and buildings built or renovated from the 1960's through the 1980's.

Visual inspection alone is insufficient to determine whether a textured surface contains asbestos or other hazardous compounds. To determine whether a textured surface or other coating contains asbestos or another hazardous compound, the textured surface should be sampled and tested. Fortunately, asbestos fibers are only a risk to health when the fibers are released and inhaled. Therefore, asbestos containing materials are not a risk unless the surface or other coating are disturbed and the fibers or particles become airborne.

Additionally, airborne dust is generated from many of industrial, agricultural, mining, or other operations. This dust may contain inhalation hazards and may have deleterious effects on personnel that breathe in these hazardous materials. Current dust suppression systems may not effectively encapsulate and remove the dust, particles, or other contaminants from the air. In fact, current systems may merely disperse the hazardous materials.

Therefore, there is an ongoing need for improved compositions and methods for safe removal textured materials on wall or ceilings. The compositions and methods provided safer means for removal of potentially hazardous materials.

There is additionally a need for a dust suppression system that actually removes a significant portion of the particulate matter and dust from the air.

### SUMMARY

Chemical compositions may be used to dissolve coatings and at least partially encapsulate fibers and other potentially hazardous particles in the coating. An embodiment of such a chemical composition for use in the removal of a textured or smooth surface comprising asbestos, the composition comprising an aqueous solution comprising a surfactant package and triethyl phosphate. In certain embodiments, the surfactant package may comprise an alcohol ethoxylate surfactant and sodium lauryl sulfate. wherein the surfactant is in a concentration range of from 10% by weight to 50% by weight of the composition based on the total weight of the composition and the triethyl phosphate is in a concentration range of from 3% by weight to 15% by weight. In other embodiments, the surfactants in the surfactant package may be present in a concentration from 20% by weight to 50% by weight based on the total weight of the composition; in a concentration range from 10% by weight to 35% by weight of the composition based on the total weight of the composition; in a concentration from 10% by weight to 25% by weight based on the total weight of the composition; or in a concentration from 15% by weight to 30% by weight based on the total weight of the composition.

The surfactants in the surfactant package may comprise one or more anionic surfactants, one or more cationic surfactants, one or more zwitterionic surfactants, one or more non-ionic surfactants, or a combination thereof to provide a broad spectrum of properties to the chemical composition.

The surfactant package may comprise an alcohol ethoxylate surfactant and sodium lauryl sulfate surfactant. In certain embodiments of the chemical composition, the alcohol ethoxylate surfactant may be present in a concentration from 4% by weight to 20% by weight based on the total weight of the composition or in a concentration from 6% by weight to 15% by weight based on the total weight of the composition. The alcohol ethoxylate surfactant may be isotridecanol ethoxylate, for example.

In addition to the alcohol ethoxylate surfactant and sodium lauryl sulfate, the chemical composition may comprise additional surfactants. These additional surfactants may comprise at least one of an alkyl amine oxide surfactant and alcohol ethoxylate surfactant, for example. An amine oxide surfactant is present in a concentration of from 1% by weight to 10% by weight, based on the total weight of the composition. The chemical composition may further comprise a taggant so that the application of the chemical composition may be identified.

Triethyl phosphate may allow the chemical composition to penetrate into cracks and pits in the substrate to be cleaned and triethyl phosphate may be in a concentration range of from 3% by weight to 15% by weight of the total weight of the chemical composition. The balance of the chemical composition may be at least one of water or an organic solvent.

In one embodiment, the chemical composition may comprise alcohol ethoxylate surfactant in a concentration range of from 0.5 to 15 wt. %; sodium lauryl sulfate in a concentration range of from 3 to 25 wt. %; sodium lauryl ether sulfate in a concentration range of from 0.1 to 10 wt. %; and lauryl amine oxide in a concentration range of from 0.1 to 10 wt. %, all based on the weight of the composition with triethyl phosphate in concentration range of from 3% by weight to 15% by weight of the total weight of the chemical composition. This chemical composition may be applicable for removing textured ceilings comprising asbestos.

The chemical composition may further comprise a foam stabilizer to allow the applied composition to remain in a foamy condition for longer times. The foam stabilizer may be in a concentration range of from 0.5 wt. % to 10 wt. %. by weight of the total chemical composition.

The chemical composition may be applied by various methods. One embodiment of the method for removing a textured surface from a surface may comprise contacting the textured surface with an embodiment of the chemical composition; agitating the textured surface; and removing the textured surface and the composition from the surface. The method may further comprise applying a solid absorbent to the agitated textured surface and the composition and then collecting the absorbent to assist in removing the textured surface and the composition.

### DESCRIPTION

Chemical compositions may be applied to coatings including textures surfaces, textured coatings, asbestos containing textured or smooth coatings, or coatings comprising other hazardous compounds that may best be removed more easily if the material of the coating is encapsulated. Embodiments of the chemical composition have been specifically formulated to provide t safe remediation of asbestos, Artex walls and ceilings and will effectively reduce airborne contaminants during demolition and remediation works. Embodiments of the chemical composition may be simply applied as a foam based fiber suppressant perfect for walls and ceilings that are coated in Artex or similar coatings and/or multiple layers of paint.

Embodiments of the chemical compositions may be applied to a surface of the porous material, such as removal of textured surfaces from wall, ceiling, or other substrate surfaces. The textured surfaces may comprise popcorn ceilings, for example.

Some embodiments of the compositions may also be used in dust suppression systems by producing a spray or atomized mist of the chemical compositions or diluted embodiments of the compositions. Embodiments of the chemical compositions may comprise a surfactant package, a trialkyl phosphate, water, and, optionally, foam stabilizers, for example. In another embodiment, the chemical composition may additionally comprise one or more of an organic solvent, a chemical stabilizer, a pigment, a taggants, or combinations thereof.

In one embodiment the composition comprises a surfactant package in an amount of from greater than 10% by weight to 50% by weight of a surfactant package, a trialkyl phosphate in an amount of from 1% by weight to 15% by weight, and water. As used herein, a surfactant package means one or more surfactant. In any embodiment described herein, the trialkyl phosphate may be triethyl phosphate.

In embodiments of the composition, the surfactant package may any combination of surfactants that are active in dissolving or wetting the textured surface, the porous surface or other coating. The surfactant package may comprise one or more anionic surfactants, one or more cationic surfactants, one or more zwitterionic surfactants, one or more non-ionic surfactants, or a combination thereof. For example, the surfactant package may comprise one or more of alkyl ether sulfate surfactants, amine oxide surfactant, and/or an alcohol ethoxylate for removing material that may comprise asbestos fibers.

In other embodiments, the surfactant package can be present in the chemical composition in an amount of from greater than 5% by weight to 75% by weight (e.g., from 1% by weight to 15% by weight), based on the total weight of the composition. The surfactant package may comprise at least one primary surfactant and, optionally, one or more secondary surfactants. For example, the primary surfactant may comprise from 10% by weight to 100% by weight of the surfactant package and the one or more secondary surfactants may comprise from 0% by weight to 90% by weight of the surfactant package. The primary surfactant is merely the surfactant with the highest concentration by weight in the surfactant package. There may be two or more primary surfactants if their concentrations are the similar, for example.

The surfactant package may comprise any surfactant or combination of surfactants that act to dissolve or emulsify components of the textured surface to be treated. For example, the surfactant package may comprise a non-ionic surfactant. In some embodiments, the surfactant package may comprise an ethoxylate surfactant, such as but not limited to, an ethoxylated alkyl phenol (e.g., an ethoxylated nonylphenol) or an alcohol ethoxylate (for example, a C10 to C16 alcohol ethoxylate). In other embodiments, the surfactant package may comprise a sulfate surfactant such as, but not limited to, sodium lauryl sulfate.

The primary surfactant can be present in an amount of from greater than 0% by weight to 50% by weight (e.g., from greater than 0% by weight to 10% by weight), based on the total weight of the composition. For example, the composition may comprise a surfactant package comprising at least one of one or more alkyl ether sulfate such as, but not limited to, sodium lauryl ether sulfate; an alcohol ethoxylate such as, but not limited to, isotridecanol ethoxylate, for example; an amine oxide such as, but not limited to lauryl amine oxide; fatty acid esters such as, but not limited to, fatty acid, C16-C18 and C18 methyl esters; and combinations thereof.

The trialkyl phosphate may be present in a composition in an amount of from greater than 0.5% by weight to 15% by weight, based on the total weight of the composition.

The taggant, if present, can be present in the composition in an amount of from greater than 0% by weight to 10% by weight, based on the total weight of the composition. The taggant may comprise any suitable taggant or combination of taggants. The taggant can be organo-soluble or organo-dispersible. In some embodiments, the taggant may comprise a blend of marker materials, optionally in combination with one or more light-emitting materials.

The composition may comprise a pigment such as, but not limited to, phenolphthalein, to add color to the composition as the composition is applied to provide visual indication of complete coverage and encapsulation. The pigment may change to colorless or loss its color as the composition dries.

Also provided are methods for the removal of textured surfaces and other materials comprising hazardous components. The methods may comprise contacting the textured surfaces and other materials comprising hazardous components with a composition described herein; and removing the at least a portion of the textured surfaces and other materials comprising hazardous components and the composition from the surface. In certain embodiments, the surface may comprise a ceiling, a wall, a floor, or a structural support, for example. In certain embodiments, the textured surface may be on dry wall, plaster, metal, cement, concrete, stone, wood, a polymeric material, a composite, or a combination thereof.

In some embodiments, step (a) may comprise applying a standing layer of the composition to the textured surfaces and other materials comprising hazardous components. For example, the textured surfaces and other materials comprising hazardous components can be present on a floor, and step (a) may comprise pouring or spraying the composition onto the floor.

In some embodiments, step (b) may comprise scraping or otherwise removing the textured surfaces and other materials comprising hazardous components. In some embodiments, the textured surfaces and other materials comprising hazardous components can be contacted with the composition for at least 1 hour prior to agitation.

In some applications, the textured surfaces and other materials comprising hazardous component) can be contacted with the composition for at least 2 hours (e.g., at least 4 hours) following application and prior to removal. In some embodiments, step (c) may comprise applying a solid absorbent (e.g., a sweeping compound) to the textured surfaces and other materials comprising hazardous components and the composition after removal from the substrate and collecting the absorbent to remove the textured surface and the composition.

The method may comprise mixing the composition with water. The mixing may comprise batch mixing and then application by pouring, spreading, and/or spraying the composition on the surface to be removed or on the substrate.

### Dust Suppression

Any embodiment of the composition described herein may additionally be used for dust suppression. Dust suppression may be used in building demolition, concrete cutting, concrete production plants, mineral slag handling facilities, or other areas that could benefit from dust or small particulate suppression. The mixing and spraying may be performed in a single device.

Atomization of the compositions described herein provide an excellent dust suppression system. The compositions may be atomized through use of foam box equipment. Foam box equipment or other devices comprise high pressure pumps and high-pressure nozzles to produce a fine mist of the composition. The foam box may further comprise a water supply.

The water and embodiments of the composition may be continuously mixed to a desired ratio to form a diluted composition. The diluted composition may be then pumped to a higher pressure and then passed through a nozzle to form a spray or atomized mist of the diluted composition. The composition may be pressurized to between 40 bar and 100 bar, for example.

The diluted composition may also be mixed with a stream of air to form the two-phase flow of a dust suppression composition. The two-phase flow may be directed into the dust or particulate matter and/or onto the source of the dust or particulates. Any floating dust particles be encapsulated by the composition and will fall down to the ground. The composition of the atomized composition has a low surface tension and can be atomized into droplets of similar size to the dust particles. Embodiments of the composition may have a surface tension of 10 dynes/cm to 40 dynes/cm. The dust particles can encapsulate and retain the particles more effectively than water alone.

For certain applications, embodiments of the compositions or diluted compositions may be sprayed or otherwise delivered by an unmanned aircraft or drone. The unmanned aircraft may deliver any of the embodiments of the composition described herein or their diluted forms. In some embodiments, the unmanned aircraft may be loaded with a cargo of the composition and batch sprayed or the unmanned aircraft comprise a supply line connected to a storage tank comprising the composition or diluted composition. The composition or diluted composition may be pumped from the storage tank through the supply line to sprayers equipped on the drone or unmanned aircraft. The drone may be programmed to deliver the composition in a controlled pattern or may determine its own flight path based upon cameras, central processing units, algorithms, and/or other sensors equipped on the drone or unmanned aircraft.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Disclosed are composition for decontamination of porous material, such as textured surface. The compositions may comprise a surfactant package and a trialkyl phosphate. Also provided are methods of using the compositions described herein for the removal of textured surfaces or other coatings.

### Compositions for the Removal of Textured Surfaces and Other Hazardous Coatings

Compositions for decontamination of porous material may comprise a surfactant package and a trialkyl phosphate. These components may be dissolved in water. The composition can optionally include one or more additional components as discussed below, including organic solvents, taggants, viscosity modifiers (e.g., thickening agents), pH modifying agents, co-solvents, colorants, adhesion promoters, stabilizers, foam stabilizers, chelating agents, fungicides, biocides, insecticides, and fragrances, for example.

The compositions may be sold in concentrated form or in a ready to use form. The concentrated form may be mixed with water, soft water, salt water, or a combination thereof, for example, to produce the ready to use composition. The mixing may be inline in a mixer that produces the foam or in a batch mix tank, for example.

### Trialkyl Phosphates

The compositions comprise at least one trialkyl phosphate. In certain applications, the trialkyl phosphate is triethyl phosphate. Triethyl phosphate (TEP) is a chemical compound with the formula (C₂H₅)₃PO₄ or OP(OEt)₃. TEP is a colorless liquid and is the triester of ethanol and phosphoric acid.

In embodiments of the composition, the TEP concentration is in a range of 1% by weight to 20% by weight of the composition. The TEP concentration may be higher in the concentrated form than in the ready to use form.

In other embodiments, the TEP may be in a concentration in a range of 5% by weight to 12% by weight of the composition, or in a concentration in a range of 1% by weight to a concentration of 5% by weight.

In a specific embodiment, the TEP may be in a concentration in a range of from 7% by weight to a concentration of 11% by weight.

### Surfactant Package

The surfactant package is an component of the composition. The surfactant package components are selected to dissolve and/or emulsify the textured surface from the substrate to be treated. In certain embodiments, the surfactant package can be present in the composition in an amount greater than 0% by weight (e.g., at least 5% by weight, at least 10% by weight, at least 15% by weight, or at least 20% by weight, minimum values), based on the total weight of the composition. In some embodiments, the surfactant package can be present in the composition in an amount of 70% by weight or less (e.g., 60% by weight or less, 50% by weight or less, 40% by weight or less 30% by weight or less, 20% by weight or less, 15% by weight or less, maximum values), based on the total weight of the composition.

The surfactant package can be present in the composition in an amount ranging from any of the minimum values described above to any of the maximum values described above.

For example, the surfactant package can be present in the composition in an amount of from greater than 0% by weight to 25% by weight (e.g., from 5% by weight to 15% by weight), based on the total weight of the composition.

The surfactant package may comprise a primary surfactant and optionally one or more secondary surfactants.

The primary surfactant may comprise a non-ionic surfactant, an anionic surfactant, a cationic surfactant, or a zwitterionic surfactant. In some embodiments, the primary surfactant may comprise a non-ionic surfactant. In some embodiments, the primary surfactant may comprise an anionic surfactant.

When present, the one or more secondary surfactants may comprise one or more nonionic surfactants, one or more additional anionic surfactants, one or more cationic surfactants, one or more zwitterionic surfactants, or any combination thereof.

In some embodiments, the primary surfactant may comprise at least 25% by weight (e.g., at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, at least 85% by weight, at least 90% by weight, or at least 95% by weight) of the surfactant package, based on the total weight of the surfactant package. In some embodiments, the primary surfactant may comprise 100% by weight or less (e.g., 95% by weight or less, 90% by weight or less, 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, or 30% by weight or less) of the surfactant package, based on the total weight of the surfactant package.

The primary surfactant can be present in the surfactant package in an amount ranging from any of the minimum values described above to any of the maximum values described above. For example, in some embodiments, the primary surfactant may comprise from 25% to 100% by weight (e.g., from 50% by weight to 100% by weight, or from 75% by weight to 100% by weight) of the surfactant package, based on the total weight of the surfactant package.

In some examples, the primary surfactant can be present in an amount of from greater than 0% by weight to 15% by weight (e.g., from greater than 0% by weight to 10% by weight), based on the total weight of the composition.

In some embodiments, the one or more secondary surfactants may comprise greater than 0% by weight (e.g., at least 5% by weight, at least 10% by weight, at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, or at least 70% by weight) of the surfactant package, based on the total weight of the surfactant package. In some embodiments, the one or more secondary surfactants may comprise 75% by weight or less (e.g., 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, 15% by weight or less, 10% by weight or less, or 5% by weight or less) of the surfactant package, based on the total weight of the surfactant package.

The one or more secondary surfactants can be present in the surfactant package in an amount ranging from any of the minimum values described above to any of the maximum values described above. For example, in some embodiments, the one or more secondary surfactants may comprise from greater than 0% to 75% by weight (e.g., from greater than 0% by weight to 50% by weight, from 10% by weight to 75% by weight, or from 10% by weight to 50% by weight) of the surfactant package, based on the total weight of the surfactant package.

In one embodiment, the composition comprises a surfactant package comprising an alkyl ether sulfate surfactant (such as, but not limited to, sodium lauryl sulfate) in a concentration range of from 5% by weight to 40% by weight, an amine oxide surfactant (such as but not limited to sodium amine oxide) in a concentration range of from 1§ % by weight to 20% by weight, an alcohol ethoxylate (such as but not limited to, a C10 to C16 alcohol ethoxylate) in a concentration range of from 1% by weight to 15% by weight, and, optionally, a fatty acid methyl ester surfactant in a concentration range of from 0% by weight to 20% by weight.

In another embodiment, the composition comprises a surfactant package comprising an sodium lauryl sulfate surfactant in a concentration range of from 15% by weight to 40% by weight, an sodium amine oxide surfactant in a concentration range of from 2% by weight to 20% by weight, an isotridecanol ethoxylate in a concentration range of from 2% by weight to 15% by weight, and a fatty acid, C16-C18 and C18 methyl ester surfactant in a concentration range of from 0% by weight to 20% by weight.

In a more specific embodiment, the composition comprises a surfactant package comprising an sodium lauryl sulfate surfactant in a concentration range of from 20% by weight to 40% by weight, a lauryl amine oxide surfactant in a concentration range of from 10% by weight to 20% by weight, an alcohol ethoxylate in a concentration range of from 65% by weight to 40% by weight, and a fatty acid methyl ester surfactant in a concentration range of from 0% by weight to 20% by weight.

All of the embodiments above additional comprise TEP.

In some embodiments, the surfactant package can be present in the composition in an amount greater than 0% by weight (e.g., at least 5% by weight, at least 10% by weight, at least 15% by weight, or at least 20% by weight), based on the total weight of the composition. In some embodiments, the surfactant package can be present in the composition in an amount of 70% by weight or less (e.g., 60% by weight or less, 50% by weight or less, 40% by weight or less 30% by weight or less, 20% by weight or less, 15% by weight or less, 10% by weight or less, or 5% by weight or less), based on the total weight of the composition.

The surfactant package can be present in the composition in an amount ranging from any of the minimum values described above to any of the maximum values described above.

For example, the surfactant package can be present in the composition in an amount of from greater than 0% by weight to 25% by weight (e.g., from 5% by weight to 15% by weight), based on the total weight of the composition.

Suitable anionic surfactants for use as a primary surfactant and/or a secondary surfactant include a hydrophobic tail that comprises from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that comprises a number of carbon atoms ranging from any of the minimum values described above to any of the maximum values described above. For example, in some embodiments, the anionic surfactant may comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may comprise single bonds, double bonds, triple bonds, or any combination thereof. In some embodiments, the anionic surfactant can include a branched hydrophobic tail derived from Guerbet alcohols. The hydrophilic portion of the anionic surfactant may comprise, for example, one or more sulfate moieties, one or more sulfonate moieties, one or more sulfosuccinate moieties, one or more carboxylate moieties, or any combination thereof.

In some embodiments, the anionic surfactant may comprise, for example a sulfonate, a sulfate, a sulfosuccinate, or a carboxylate. In some examples, the anionic surfactant may comprise an internal olefin sulfonate (IOS), an alfa olefin sulfonate (AOS), an alkyl aryl sulfonate (ARS), an alkane sulfonate, a petroleum sulfonate, an alkyl Biphenyl oxide sulfonate, an alcohol sulfate, an alkoxy sulfate, an alkoxy sulfonate, an alkoxy carboxylate, an alcohol phosphate, or an alkoxy phosphate. In some embodiments, the anionic surfactant may comprise an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

In some embodiments, the anionic surfactant may comprise a rosin-based surfactant (e.g., a carboxylate-containing rosin-based surfactant, a sulfate-containing rosin-based surfactant, a sulfonate-containing rosin-based surfactant, a phosphate-containing rosin-based surfactant, or a combination thereof). Examples of rosin-based surfactants include those described in the attached Appendix, the contents of which are incorporated herein by reference.

In some embodiments, the anionic surfactant may comprise an alkyl benzene sulfonate.

In some embodiments, the anionic surfactant may comprise an alpha olefin sulfonate.

An “alkoxy carboxylate surfactant” or “alkoxy carboxylate” refers to a compound having an alkyl or aryl attached to one or more alkoxylene groups (typically -CH2-CH(ethyl)-O—, -CH2-CH(methyl)-O—, or -CH2-CH2-O—) which, in turn is attached to —COO or acid or salt thereof including metal cations such as sodium. In embodiments, the alkoxy carboxylate

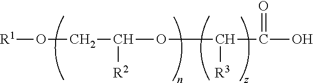

surfactant can be defined by the formulae below: or

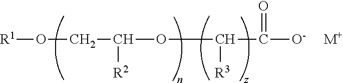

wherein R¹ is substituted or unsubstituted C6-C36 alkyl or substituted or unsubstituted aryl; R² is, independently for each occurrence within the compound, hydrogen or unsubstituted C1-C6 alkyl; R³ is independently hydrogen or unsubstituted C1-C6 alkyl, n is an integer from 0 to 175, z is an integer from 1 to 6 and M is a monovalent, divalent, or trivalent cation. In some of these embodiments, R¹ can be an unsubstituted linear or branched C6-C36 alkyl.

An “alkoxy sulfate surfactant” or “alkoxy sulfate” refers to a surfactant having an alkyl or aryl attached to one or more alkoxylene groups (typically -CH2-CH(ethyl)-O—, -CEb-CH(methyl)-O—, or -CH2-CH2-O—) which, in turn is attached to -SO3 or acid or salt thereof including metal cations such as sodium. In some embodiment, the alkoxy sulfate surfactant has the formula R-(BO)ₑ-(PO)f-(EO)-SO3 or acid or salt (including metal cations such as sodium) thereof, wherein R is C6-C32 alkyl, BO is -CH2-CH(ethyl)-O—, PO is -CH2-CH(methyl)-O—, and EO is -CH2-CH2-O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically -CH2-CH(ethyl)-O—, -CH2-CH(methyl)-O—, or -CH2-CH2-O—) which, in turn is attached to -SO3 or acid or salt thereof including metal cations such as sodium.

An “alkyl sulfonate surfactant” or “alkyl sulfonate” refers to a compound an alkyl group (e.g., a branched or unbranched C6-C32 alkyl group) attached to -SO3 or acid or salt thereof including metal cations such as sodium.

An “aryl sulfate surfactant” or “aryl sulfate” refers to a compound having an aryl group attached to —O-SO3 or acid or salt thereof including metal cations such as sodium. An “aryl sulfonate surfactant” or “aryl sulfonate” refers to a compound having an aryl group attached to -SO3′ or acid or salt thereof including metal cations such as sodium. In some cases, the aryl group can be substituted, for example, with an alkyl group (an alkyl aryl sulfonate).

An “internal olefin sulfonates” or “IOS” refers to an unsaturated hydrocarbon compound comprising at least one carbon-carbon double bond and at least one SO4 group, or a salt thereof. As used herein, a “C20-28 internal olefin sulfonate” or “C20-28 IOS” refers to an IOS, or a mixture of IOSs with an average carbon number of 20 to 28, or of 23 to 25. The C20-28 IOS may comprise at least 80% of IOS with carbon numbers of 20 to 28, at least 90% of IOS with carbon numbers of 20 to 28, or at least 99% of IOS with carbon numbers of 20 to 28. As used herein, a “CI 5-18 internal olefin sulfonate” or “C₁₋₅-18 IOS” refers to an IOS or a mixture of IOSs with an average carbon number of 15 to 18, or of 16 to 17. The CI 5-18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates may be alpha olefin sulfonates, such as an isomerized alpha olefin sulfonate. The internal olefin sulfonates may also comprise branching. The IOS may be at least 20% branching, 30% branching, 40% branching, 50% branching, 60% branching, and 65% branching. In some embodiments, the branching is between 20-98%, 30-90%, 40-80%, or around 65%. Examples of internal olefin sulfonates and the methods to make them are found in U.S. Pat. No. 5,488,148, and U.S. Patent Application Publication 2009/0112014, all incorporated herein by reference.

In embodiments, the anionic surfactant can be an alkylbenzene sulfonate or a dibenzene di-sulfonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C30), internal olefin sulfonate (C6-C30) or internal olefin di-sulfonate (C6-C30). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) Sulfonate: where the alkyl group is linear or branched C6-C36. In some embodiments, the anionic surfactant is a sulfosuccinate. In some embodiments, the anionic surfactant is an alkyl aryl sulfonate (ARS) (e.g., an alkyl benzene sulfonate (ABS)), a C10-C30 internal olefin sulfate (IOS), or an alkyl Biphenyl oxide sulfonate.

Suitable non-ionic surfactants for use as a secondary surfactant include compounds that can be added to increase to increase wettability. In embodiments, the HLB of the non-ionic surfactant is greater than 10 (e.g., greater than 9, greater than 8, or greater than 7. In some embodiments, the HLB of the non-ionic surfactant is from 7 to 10.

The non-ionic surfactant may comprise a hydrophobic tail comprising from 6 to 36 carbon atoms. In some embodiments, the non-ionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, or at least 35 carbon atoms). In some embodiments, the non-ionic surfactant can include a hydrophobic tail that comprises 36 carbon atoms or less (e.g., 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, the non-ionic surfactant may comprise a hydrophobic tail comprising from 6 to 15, from 16 to 30, from 31 to 36, from 6 to 25, from 26 to 30, from 6 to 32, from 6 to 12, from 13 to 22, from 23 to 32, from 33 to 36, from 6 to 10, from 10 to 15, from 16 to 25, or from 26 to 36 carbon atoms. In some cases, the hydrophobic tail may be a straight chain, branched chain, and/or may comprise cyclic structures. The hydrophobic carbon tail may comprise single bonds, double bonds, triple bonds, or any combination thereof. In some cases, the hydrophobic tail may comprise an alkyl group, with or without an aromatic ring (e.g., a phenyl ring) attached to it. In some embodiments, the hydrophobic tail may comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkylene oxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the nonionic surfactant could comprise 10EO:SPO or 5E0. In embodiments, the non-ionic surfactant may be a mix of surfactants with different length lipophilic tail chain lengths. For example, the non-ionic surfactant may be C9-C11:P09:E02, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C1-C36. In some examples, the non-ionic surfactant may comprise a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), or any combination thereof).

Example cationic surfactants include surfactant analogous to those described above, except bearing primary, secondary, or tertiary amines, or quaternary ammonium cations, as a hydrophilic head group. “Zwitterionic” or “zwitterion” as used herein refers to a neutral molecule with a positive (or cationic) and a negative (or anionic) electrical charge at different locations within the same molecule. Example zwitterionic surfactants include betains and sultains.

Examples of suitable surfactants are disclosed, for example, in U.S. Pat. Nos. 3,811,504, 3,811,505, 3,811,507, 3,890,239, 4,463,806, 6,022,843, 6,225,267, 7,629,299 7,770,641, 9,976,072, 8,211, 837, 9,422,469, 9,605,198, and 9,617,464; WIPO Patent Application WO/2008/079855, WO/2012/027757 and WO/2011/094442; as well as U.S. Patent Application Nos. 2005/0199395, 2006/0185845, 2006/018486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, 2010/0292110, and 2017/098202, each of which is hereby incorporated by reference herein in its entirety for its description of example surfactants.

In certain embodiments, the surfactant package may comprise a non-ionic primary surfactant. In some embodiments, the primary surfactant may comprise an ethoxylated alkyl phenol (e.g., an ethoxylated nonylphenol).

### Stabilizers

The compositions may further comprise stabilizers to stabilize the foam and/or the chemical composition. These stabilizers, in certain embodiments, comprise at least one of urea and glycerol. The stabilizers may be present in the composition in any concentration effective to stabilize the foam. Foam stability may be measured by the height of the foam over time, for example. If the stabilizer slows the reduction of foam height over time, the foam is considered more stable.

In some embodiments, the stabilizers may be added in a concentration range of from 0.5% by weight to 20% by weight. In embodiments of the invention, the foam stabilizer may be any know surfactant foam stabilizer and the stabilizer may be chosen based upon the components of the surfactant package.

In one embodiment, the composition comprises a surfactant package comprising a sodium lauryl sulfate in a concentration range of from 10% by weight to 40% by weight, a sodium amine oxide in a concentration range of from 10§ % by weight to 20% by weight, a CIO to C16 alcohol ethoxylate) in a concentration range of from 40% by weight to 60% by weight, and, optionally, a fatty acid methyl ester surfactant in a concentration range of from 0% by weight to 20% by weight, each of the weight of the surfactant package; triethyl phosphate in a concentration range of from 5% by weight to 15% by weight of the complete composition; and stabilizers in the range of 5% by weight to 20% by weight of the complete composition. The stabilizers may be at least one of urea and glycerol, for example.

### Organic Solvent

The chemical composition may comprise an organic solvent or water. In some embodiments, the organic solvent can be present in the composition in an amount of at least 50% by weight (e.g., at least 55% by weight, at least 60% by weight, at least 65% by weight, at least 70% by weight, at least 75% by weight, at least 80% by weight, or at least 85% by weight, at least 90% by weight, or at least 95% by weight), based on the total weight of the composition. In some embodiments, the organic solvent can be present in the composition in an amount of 98% by weight or less (e.g., 95% by weight or less, 90% by weight or less, 85% by weight or less, 80% by weight or less, 75% by weight or less, 70% by weight or less, 65% by weight or less, 60% by weight or less, or 55% by weight or less), based on the total weight of the composition.

The organic solvent, if present, can be present in the composition in an amount ranging from any of the minimum values described above to any of the maximum values described above. For example, the organic solvent can be present in the composition in an amount of from 50% by weight to 98% by weight (e.g., from 75% by weight to 98% by weight), based on the total weight of the composition.

In some embodiments, the taggant, if present, can be present in the composition in an amount greater than 0% by weight (e.g., at least 0.5% by weight, at least 1% by weight, at least 2% by weight, at least 3% by weight, at least 4% by weight, at least 5% by weight, at least 6% by weight, at least 7% by weight, at least 8% by weight, or at least 9% by weight), based on the total weight of the composition. In some embodiments, the taggant can be present in the composition in an amount of 10% by weight or less (e.g., 9% by weight or less, 8% by weight or less, 7% by weight or less, 6% by weight or less, 5% by weight or less, 4% by weight or less, 3% by weight or less, 2% by weight or less, 1% by weight or less, or 0.5% by weight or less), based on the total weight of the composition.

The organic solvent may comprise any suitable organic solvent. Examples of organic solvents include lactones such as g-butyrolactone, g-valerolactone, g-caprolactone, g-heptalactone, a-acetyl-g-butyrol actone, and e-caprolactone; ethers such as dioxane, 1,2-dimethoxymethane, diethylene glycol dimethyl ether, diethylene glycol diethyl ether, diethylene glycol dibutyl ether, propylene glycol monomethyl ether, propylene glycol monoethyl ether, triethylene glycol dimethyl ether, triethylene glycol diethyl ether, tetra ethylene glycol dimethyl ether, and tetra ethylene glycol diethyl ether; carbonates such as ethylene carbonate and propylene carbonate; ketones such as methyl ethyl ketone, methyl isobutyl ketone, cyclohexanone, and acetophenone; phenols such as phenol, cresol, and xylenol; esters such as ethyl acetate, butyl acetate, methyl lactate, ethyl cellosolve acetate, butyl cellosolve acetate, carbitol acetate, butyl carbitol acetate, and propylene glycol monomethyl ether acetate; hydrocarbons such as toluene, xylene, diethylbenzene, and cyclohexane; halogenated hydrocarbons such as trichloroethane, tetrachloroethane, and monochlorobenzene; organic solvents such as petroleum type solvents (e.g. petroleum ether, petroleum naphtha); fluoro-alcohols such as 2H,3H-tetrafluoropropanol; hydrofluoroethers such as perfluorobutyl methyl ether and perfluorobutyl ethyl ether; alcohols such as methyl alcohol, ethyl alcohol, isopropyl alcohol, and n-propyl alcohol; and diacetone alcohols combing performances of both of ketone and alcohol.

In some embodiments, the organic solvent may comprise a bio-based solvent. As used herein, the term “bio-based” refers to a solvent that is either derived from a biological source (e.g., a plant such as soybeans), is biodegradable, or a combination thereof.

In certain embodiments, the organic solvent may comprise a vegetable oil or derivative thereof. For example, the organic solvent may comprise soybean oil, rape seed oil, corn oil, sunflower oil, palm kernel oil, coconut oil, cottonseed oil, olive oil, palm oil, peanut oil, safflower oil, sesame oil, nut oils, melon seed oils, gourd seed oils, flax seed oil, hemp oil, wheat germ oil, castor oil, rice bran oil, tung oil, other vegetable/fruit oils, animal fat (including tallow, lard, yellow grease and fish-oil), algae oil, copaiba, oil from halophytes, oil from fungi, or derivatives thereof. Derivatives of these oils include, for example esters (e.g., methyl esters) and epoxidized esters of fatty acid obtained from one of these biological sources. Derivatives are also described, for example, in U.S. Pat. No. 7,951,766, which is hereby incorporated herein by reference. Other examples of bio-based surfactants include lactate esters (e.g., produced from processes using sugar, starches and oils and high-performance microbial fermentation), such as ethyl lactate.

In some examples, the organic solvent may comprise a soybean oil derivative (e.g., methyl soy ate).

### Taggant

The taggant, if present, can be present in the composition in an amount ranging from any of the minimum values described above to any of the maximum values described above. For example, the taggant can be present in the composition in an amount of from greater than 0% by weight to 10% by weight, based on the total weight of the composition.

The compositions described herein further include a taggant. The term “tag” or “taggant” is well known in the art, and generally refers to a component or composition that is suitable for the purpose of detecting or identifying an article or composition to which taggant is applied or incorporated. The taggant can be overt, covert, invisible or otherwise difficult to detect on individual entities or small numbers of entities, yet having an overt signal detectable from all or a larger number of entities. For example, the entity can be labeled with one or more colors, fluorescent dyes, ultraviolet radiation dyes, luminescent compositions, haptens, nucleotides, polypeptides, or scents. A single entity can be labeled with more than one tag of the same or different types. For example, a particle can be labeled with two or more discretely distinguishable dyes in varying proportion; or a particle can be labeled with a nucleotide and a fluorescent dye. Any of the known tags and the combinations of the tags with entities can be used. Methods known to those skilled in the art can be used to label an entity with one or more taggants. For example, U.S. Pat. No. 6,632,526 teaches methods of dyeing or staining microspheres with at least two fluorescent dyes in such a manner that intra-sample variation of dye concentrations are substantially minimized. The entity can be a segmented particle whose composition is varied along the diameter or the length of the particle. U.S. Pat. No. 6,919,009 teaches methods of manufacture of rod-shaped particles.

In some embodiments, the taggant may comprise an organo-soluble or organo-dispersible taggant. In some embodiments, the taggant may comprise a blend of marker materials, optionally in combination with one or more light-emitting materials. Marker materials are materials that can be identified using known analytical techniques including, without limitation, spectroscopic and chromatographic techniques, for example mass spectrometry, atomic emission spectroscopy, laser induced breakdown spectroscopy, gas chromatography and gel electrophoresis.

A unique marker composition may be formed by varying parameters including, without limitation, identity of a marker; combination of different marker materials; concentration of an individual marker within the composition; and relative concentrations of two marker materials.

The taggant may include a single marker material, but preferably contains a plurality of different marker materials at least two, at least three, at least four, at least five or at least ten, at least twenty different marker materials. Optionally, the taggant comprises up to forty or up to thirty different marker materials. Concentration of marker materials may be measured by ICP-mass spectrometry or ICP atomic emission spectroscopy as a weight per volume of the marker material.

The greater the number of marker materials used, the greater the number of unique combinations available for use. Furthermore, a greater number of marker materials in a taggant may provide a greater degree of certainty in identification of the source of the composition.

The concentration of each marker material may be between 0.0000001%-15% (1 ppb-150,000 ppm) for each component, optionally 5-100,000 pm, optionally 100-10,000 ppm. Optionally each marker material is provided in an amount of at least 25 ppm, optionally at least 50 ppm.

A marker composition may be formed as described in UK Patent GB 2413674, the contents of which are incorporated herein by reference. The formulation of unique combinations of marker materials can be prepared using a binary method; however other methods comprising octal and hexadecimal strings can also be used. Each marker composition is held on a database of forensic codes and assigned to a specific owner and/or location. With this database, forensic analysis of a marker composition in a composition or on material treated with a composition can be used to verify the authenticity of a composition or to verify that a material was properly remediated using a composition described herein.

Preferably, each marker is an uncommon material provided at a concentration that would not normally be present in the field of use. Exemplary marker materials are metal compounds and organic compounds.

Exemplary metals of metal compound markers include alkaline earth metals, d-block metals, lanthanides, for example Lanthanum, Europium and Holmium; and p-block metals, for example Tellurium and Gallium.

Exemplary organic marker compounds include, tetrahydrocarbazole derivatives and methoxybenzonitrile derivatives.

The marker material may be dissolved or dispersed in the composition.

Preferably, the marker or markers material is dissolved and the metal salt may be selected accordingly. Exemplary metal compound markers include metal oxides, metal triflates, metal halides, metal nitrates, metal sulfates, and metal sulfides.

The taggant can further include at least one light-emitting material, preferably a photoluminescent light-emitting material. The light-emitting material may independently be fluorescent or phosphorescent. This material can act as a preliminary indicator to indicate the presence of the taggant in the composition or on a material. Upon preliminary identification, the composition may be analyzed in detail to identify the markers in the composition.

This indicator can be either overt and/or covert. Overt indicators emit light in the visible wavelength that can be seen without any apparatus and may be selected from, for example, microdots, pigments, and dyes. Covert indicators can be viewed only with the use of a suitable stimulus, for example photoluminescent materials that only emit visible radiation when excited by radiation other than visible light, for example upon excitation with a UV lamp.

Preferably, the light-emitting material is water soluble or water dispersible.

More than one light-emitting material may be present in the composition, for example materials that emit radiation of different wavelengths, for initial identification of the composition.

Exemplary covert indicators are coumarins, oxazinones, stilbenes, fluoresceins and derivatives thereof. Coumarins, oxazinones, stilbenes and derivatives thereof are preferred.

The light-emitting material may be used in a concentration of between 0.05 to 40% by weight of the composition.

Suitable taggants include those sold under the tradename SMARTWATER by SmartWater Technology Ltd. (Shropshire, U.K.). Examples include “Index Solutions” (a water based solution containing low level additives, such as metals (rare-earth lanthanides), which are blended using a binary sequence to ensure uniqueness); “Indsol Tracer” (a polymer emulsion that blends different chemical agents according to a binary code), and “SmartWater Instant (fragments of a copolymer of vinyl acetate in isopropyl alcohol). Such taggants are described, for example, in U.S. Pat. Nos. 5,811,152; 10,035,951, and U.S. Patent Application Publication No. 2015/0332613, all of which are incorporated herein by reference.

### Additional Components

The composition can optionally include one or more additional components, including viscosity modifiers (e.g., thickening agents), pH modifying agents, co-solvents, colorants, adhesion promoters, stabilizers, chelating agents, fungicides, biocides, insecticides, and fragrances.

In some embodiments, the composition can further comprise a viscosity modifier, such as a polymer. When present, the viscosity modifier can be present in the composition an amount of from greater than 0% by weight to 10% by weight, based on the total weight of the composition.

In some embodiments, the composition can further comprise a pH modifying agent (e.g., an acid, a base, or a combination thereof). In some embodiments, the composition can have an effective amount of a pH modifying agent to provide a pH of from 7.5 to 10. In certain embodiments, the pH modifying agent may comprise sodium hydroxide, potassium hydroxide, or a combination thereof.

In some embodiments, the composition can further comprise D-Limonene. When present, the D-Limonene can be present in the composition an amount of from greater than 0% by weight to 5% by weight, based on the total weight of the composition.

In some embodiments, the composition further comprises a co-solvent. The co-solvent comprises an alcohol or an ether. For example, the co-solvent may comprise butylene glycol, hexylene glycol, ethoxy diglycol, dipropylene glycol, ethylene glycol, propylene glycol, ethanol, isopropanol, or a combination thereof. When present, the co-solvent can be present in the composition an amount of from greater than 0% by weight to 20% by weight (e.g., from greater than 0% by weight to 10% by weight), based on the total weight of the composition.

In some embodiments, the composition can further include a chelating agent, such an ethylenediamine tetraacetic acid (EDTA) or a salt thereof.

### Methods of Use

Also provided are methods for the removal of textured surfaces, popcorn ceilings, or other porous coating potentially comprising a hazardous component (herein “textured surface”) The methods may comprise contacting the textured surface with a composition described herein and removing the textured surface and the composition from the surface or other areas of the work site. In certain embodiments, the surface may comprise a wall, a floor, or a structural support. In certain embodiments, the surface may be on a metal, cement, concrete, stone, wood, a polymeric material, a composite, or a combination of these substrates.

In some embodiments, step (a) may comprise applying a standing layer of the composition to the textured surface. For example, the textured surface can be present on a floor, and step (a) may comprise pouring or spraying the composition onto the floor.

In some embodiments, step (b) may comprise scrubbing the textured surface (e.g., with a bristled brush). In some embodiments, the textured surface can be contacted with the composition for at least 1 hour (e.g., at least 2 hours, at least 3 hours, or at least 4 hours) prior to agitation.

The textured surface can be contacted with the composition for at least 2 hours (e.g., at least 4 hours, or at least 6 hours) following agitation and prior to removal.

In some embodiments, step (c) may comprise applying a solid absorbent (e.g., a sweeping compound) to the textured surface and the composition and collecting the absorbent to remove the textured surface and the composition.

In some embodiments, the method can further comprise applying a stain remover to the surface.

The presence of a taggant in the compositions described herein provides a mechanism for the authentication of the composition, a mechanism for confirmation that a textured surface has been properly cleaned and removed using a composition described herein, a mechanism for tracking removed textured surface, or a combination thereof.

Accordingly, provided herein are methods for confirming that a textured surface has been properly cleaned and removed. These methods may comprise (a) interrogating waste comprising the textured surface for the presence of a taggant; and (b) assessing the identity of the taggant to confirm that textured surface was removed using a composition described herein. Assessing the identity of the taggant may comprise, by way of example, spectroscopically and/or spectrometrically interrogating the taggant in the composition to identify the taggant present in the composition. Assessing the identity of the taggant can further comprise consulting a tracking registry to confirm the identity of the composition used to remove the textured surface.

Also provided are methods for tracking removal of a textured surface. These methods may comprise (a) providing a composition described herein; (b) uniquely registering the taggant in the composition with a site comprising the textured surface in a tracking registry; (c) contacting the textured surface with a composition described herein; (d) agitating the textured surface in the presence of the composition; (e) removing the textured surface and the composition from the surface; (e) transferring the textured surface and associated waste to a storage device; (f) transporting the storage device containing the material to a waste disposal facility; and (g) disposing of the material at the waste disposal facility. In some cases, the method can further comprise interrogating the material for the presence of the taggant upon arrival at the waste disposal facility, uniquely registering the taggant with the waste disposal facility in the tracking registry, or a combination thereof.

In some embodiments, the method can further comprise inputting additional information related to removal of the material in the tracking registry. The additional materials may comprise, for example, a date of removal, a date of disposal, a monitoring person responsible for removal, a monitoring person responsible for disposal, an identity of the textured surface, a quantity of the textured surface in the storage device, or a combination thereof.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative components, compositions, and method steps disclosed herein are specifically described, other combinations of the components, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. A composition for use in the removal of a textured surface, the composition comprising:
a surfactant package comprising an alcohol ethoxylate surfactant and sodium lauryl sulfate surfactant, wherein the surfactant is in a concentration range of from 10% by weight to 35% by weight of the composition based on the total weight of the composition;
triethyl phosphate is in a concentration range of from 3% by weight to 15% by weight; and
water.

2. The composition of claim 1, wherein the surfactant package is present in an amount of from greater than 10% by weight to 25% by weight based on the total weight of the composition.

3. The composition of claim 2, wherein the surfactant package is present in an amount of from 15% by weight to 30% by weight based on the total weight of the composition.

4. The composition of any of claim 1, wherein the alcohol ethoxylate surfactant is present in an amount of from greater than 4% by weight to 20% by weight based on the total weight of the composition.

5. The composition of claim 1, wherein the alcohol ethoxylate surfactant is present in an amount of from greater than 6% by weight to 15% by weight based on the total weight of the composition.

6. The composition of claim 1, wherein the one or more secondary surfactants comprises at least one of an alkyl amine oxide surfactant and alcohol ethoxylate surfactant.

7. The composition of claim 6, wherein the alcohol ethoxylate surfactant is an isotridecanol ethoxylate and is in a concentration from 5% by weight to 12% by weight.

8. The composition of claim 1, wherein the surfactant package comprises one or more anionic surfactants, one or more cationic surfactants, one or more zwitterionic surfactants, one or more non-ionic surfactants, or a combination thereof.

9. The composition of claim 1, comprising an organic solvent.

10. The composition of claim 1, wherein the surfactant package comprises an amine oxide surfactant.

11. The composition of claim 10, wherein the amine oxide surfactant is presen§ t in an amount of greater than 1% by weight to 10%, based on the total weight of the composition.

12. The composition of claim 1, comprising a taggant.

13. A composition for use in the removal of a textured surface comprising asbestos, the composition comprising:
a surfactant package comprising an alcohol ethoxylate surfactant and sodium lauryl sulfate, wherein surfactants in the surfactant package are in a concentration range of from 10% by weight to 50% by weight of the composition based on the total weight of the composition;
triethyl phosphate is in a concentration range of from 3% by weight to 12% by weight; and
water.

14. The composition of claim 13, wherein the surfactant package is present in an amount of from greater than 20% by weight to 50% by weight based on the total weight of the composition.

15. The composition of claim 14, wherein the surfactant package comprises sodium lauryl ether sulfate and lauryl amine oxide.

16. The composition of any of claim 15, wherein the alcohol ethoxylate surfactant is present in an amount of from greater than 4% by weight to 20% by weight based on the total weight of the composition.

17. The composition of claim 15, wherein the alcohol ethoxylate surfactant is present in an amount of from greater than 6% by weight to 15% by weight based on the total weight of the composition.

18. The composition of claim 15, comprising:
the alcohol ethoxylate surfactant in a concentration range of from 0.5 to 15 wt. %;
the sodium lauryl sulfate in a concentration range of from 3 to 25 wt. %;
sodium lauryl ether sulfate in a concentration range of from 0.1 to 10 wt. %; and
lauryl amine oxide in a concentration range of from 0.1 to 10 wt. %, all based on the weight of the composition.

19. The composition of claim 18, comprising a foam stabilizer in a concentration range of from 0.5 to 10 wt. %.

20. The composition of claim 19, comprising a stabilizer in a concentration range of from 0.5 to 10 wt. %.

21. The composition of claim 18, wherein the alcohol ethoxylate surfactant is isotridecanol ethoxylate and is in a concentration from 5% by weight to 12% by weight of the composition.

22. The composition of claim 13, wherein the surfactant package comprises one or more anionic surfactants, one or more cationic surfactants, one or more zwitterionic surfactants, and one or more non-ionic surfactants.

23. The composition of claim 13, comprising a taggant.

24. A method for removing a textured surface from a surface, the method comprising:
(a) contacting the textured surface with the composition of claim 8;
(b) agitating the textured surface;
(c) removing the textured surface and the composition from the surface.

25. The method of claim 24, wherein step (c) comprises applying a solid absorbent to the textured surface and the composition and then collecting the absorbent to remove the textured surface and the composition.

26. The method of claim 24, wherein step (a) comprises applying a standing layer of the composition of claim 1 to the textured surface.

27. The method of claim 24, further comprising applying a stain remover to the surface.

28. The method of claim 24, wherein the textured surface comprises textured surface.
